(19) United States
(12) Patent Application Publication
(10) Pub. No.: US 2022/0180772 A1
(43) Pub. Date: Jun. 9, 2022

(54) REUSEABLE BEST-BY DATE INDICATOR

(71) Applicants: Sayaka INAI, Kanagawa Pref. (JP); Yuna KODERA, Chiba Pref. (JP); Mio ITO, Tokyo (JP); Yuya HIRANO, Kanagawa Pref. (JP); Ryunosuke NISHIKAWA, Chiba Pref. (JP); Junichiro ITO, Tokyo (JP); Sota ANDO, Saitama Pref. (JP); Motoki NAKAMURA, Kanagawa Pref. (JP); Ai SATO, Tokyo (JP)

(72) Inventors: Sayaka INAI, Kanagawa Pref. (JP); Yuna KODERA, Chiba Pref. (JP); Mio ITO, Tokyo (JP); Yuya HIRANO, Kanagawa Pref. (JP); Ryunosuke NISHIKAWA, Chiba Pref. (JP); Junichiro ITO, Tokyo (JP); Sota ANDO, Saitama Pref. (JP); Motoki NAKAMURA, Kanagawa Pref. (JP); Ai SATO, Tokyo (JP)

(21) Appl. No.: 17/680,307

(22) Filed: Feb. 25, 2022

(51) Int. Cl. G09F 3/02; C01B 33/14

(52) U.S. Cl. CPC G09F 3/02; C01B 33/14; G09F 2003/0208; C01P 2006/90; G09F 2003/0264; C01P 2006/60; G09F 2003/023

(57) ABSTRACT

A reusable best-by date indicator incudes a main body, which is made of a transparent material, having a plurality of storages, the main body having a first air vent at one end through which outside air can be drawn in and a second air vents between the storages; a plurality of silica gels, each of which is stored in the storages, respectively, the gels changing their color depending on the degree of moisture absorption; a slidable cover that is placed near the first air vent of the body and can exposes the first air vent by slide; and a double-sided tape attached bonded to the back surface of the body.

### BACKGROUND OF THE INVENTION

1. Field of the Invention

This invention has been made by the members of MIMURA Seminar, College of Law, Nihon Univ. as a team. The present invention relates to an indicator with removable tape, specifically to a reusable indicator having silica gel that can be visually confirmed the expiration date or best-by date of the product on which the indicator is attached.

2. Description of the Related art

In the conventional technology, the expiration date or best-by date of products is generally printed thereon, Specifically, it is shown on the outer box or its package. But in some cases, such as cosmetics and other similar items, the expiration date or best-by date is not indicated at all. Use of such products whose best-by date is overdue will cause damage to health. For example, in case of eye drops, even though the best-by date is printed on the its case, it is written in text, so it is continuously used after the best-by date without noticing it. As a result, there is a risk of eye disease. In case of lipstick or mascara, it may cause dermatitis due to bacteria and viruses attached.

If the best-by date is not mentioned on the product, the date, which start using, can be written by the user. But, it is not uncommon for some people to consciously write the starting date of using, but there are problems with the time and effort required to enter it and the speed of recognition when visually recognizing it. The risk of accidental ingestion is also taken into consideration.

In some cases, the expiration date or the best-by may not be confirmed when disposing of the stated item because the best-by date may be written on the outer box, packaging, or attached sheet instead of the product itself, Further, some chemicals generally have a guideline for use on the packaging and instruction manual showing the direction to write the starting date of use thereon.

However, it is possible to accidentally dispose of the packaging or instruction manual on which the starting date is written, or to forget to record the date. In addition, cosmetics, especially lipsticks and mascara, generally have no best-by date, so there is a possibility that the cosmetics will be used in a state where there is a possibility of inflammation or blindness. Therefore, there has been a strong demand for an indicator that can be directly attached to the main body to be used and that the best-by date can be visually confirmed by color instead of letters.

### SUMMARY OF THE INVENTION

An object of the present invention is to solve the above problems, and to provide a reusable best-by date indicator including a main body, which is made of a transparent material, having a plurality of storages, the main body having a first air vent at one end through which outside air can be drawn in and a second air vents between the storages; a plurality of silica gels, each of which is stored in the storages, respectively, the gels changing their color depending on the degree of moisture absorption; a slidable cover that is placed near the first air vent of the body and exposes the first air vent by slide; and a double-sided tape attached the back surface of the body.

### BRIEF DESCRIPTION OF THE DRAWINGS

The above-described and other objects and features of the present invention will be apparent from the following embodiments, which are described with reference to the accompanying drawings, in which:

FIG. 1 is a perspective view of a best-by date indicator of the present invention,

FIG. 2 is a side view of one end of the indicator shown in FIG. 1, and

FIG. 3 is a perspective view of a concave slidable cover used in the indicator of the present invention.

### DETAILED DESCRIPTION OF THE PREFERRED EMBODIMENT

Preferred embodiments of the present invention are described below, together with the drawings, In each drawing, the same reference numbers indicate the same or similar components that run through all embodiments,

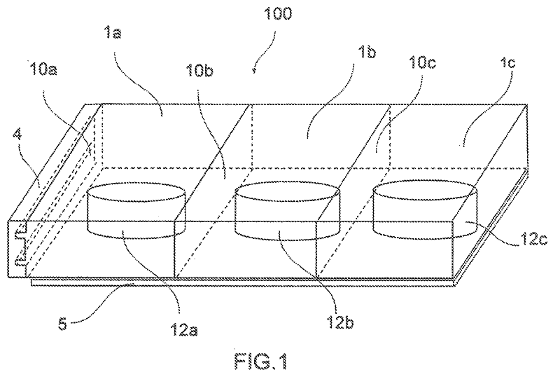

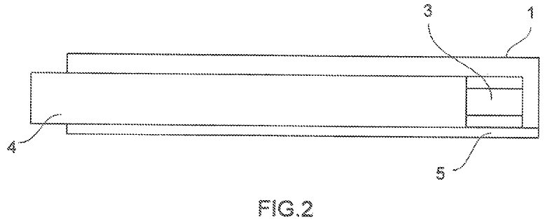

FIG. 1 shows a perspective view of a best-by date indicator showing the whole concept of the embodiment of the present invention, and FIG. 2 shows is a side view of the best-by date indicator according to the embodiment of the present invention. A best-by date indicator (hereinafter it is simply called as indicator) 100 includes a main body 1, a slidable cover 4 engaged with the main body 1, and a double-sided tape 5 formed on the back surface of the main body

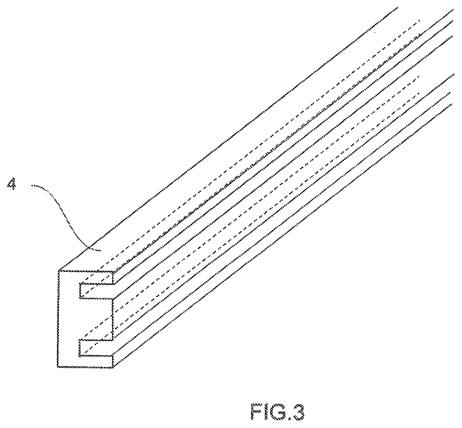

The main body 1 includes has first through to third storages 1a, 1b and 1c, and the main body 1 incudes a first air vent 10a at its one end, and also includes a second vent 10b and a third air vent 10c between first through third storages 1a, 1b and 1c so that each of the storages 1a, 1b and 1c are separated by the second and third air vents 10b and 10c. Further, a concave rail 3 is formed in the first vent 10a, and since the slidable cover 4 is formed in convex shape as shown in FIG. 1 and FIG. 3, it is possible that the slidable cover 4 is coupled with and slides on the concave rail 3. Each of the first through third vents is a mesh so air can pass through.

Each of a first silica gel types A 12a, a second silica gel types A 12b and a third silica gel types A 12c (hereinafter they are referred as the first gel, the second gel and the third gel) is placed in the first through third storages 1a, 1b and 1c, respectively. The materials of the first through third gels 12a, 12b and 12c used here are all the same, and cobalt chloride is adsorbed on each of them so that the color is blue in the dry state. The color of the first through third gels 12a, 12b and 12c gradually changes to pink when they absorb the moisture in the air by use. That is, each of the first through third gels 12a, 12b and 12c changes to a light pink from blue color when the amount of moisture absorption is small, and change to a deep pink color when the amount of moisture absorption is large. In other words, since the distance from the place where the first gel 12a is placed to the first vent 10a is different from the distance from the place where the second gel 12b is placed to the first vent 10a, the color of the first gel 12a will change initially and then the color of the second gel 12b will change. Each of the first through third gels 12a, 12b and 12c is covered with a transparent film such as plastic,and the color change is visible from the outside.

The main body 1 is made of transparent plastic with heat resistant material and has a thickness of about 5 mm, The concave rail 3 is also made of transparent plastic as same as like the main body 1, The first through third storages 1a, 1b and 1c have almost the same shape. The slidable cover 4 is made of plastic and has a thickness of about 5 mm as same as the main body 1. Moreover, since the slidable cover 4 does not contact with the double-sided tape 5, which is placed on the back surface of the main body 1 it can slide.

The double-sided tape 5 is made of acrylic and has a thickness of about 2 mm. Further, the double-sided tape 5 is placed in the matter that the tape 5 is not interfering with the operation of the cover 4. By using of the double-sided tape 5, the indicator 100 can be attached to the product relatively firmly, and be detached from it after use.

The indicator 100 shown in FIG. 1 and FIG. 2 is used as follows. When a product such as chemicals and cosmetics whose best-by date is not specified on the main body starts using, the indicator 100 is attached to the product initially by the double-sided tape 5. After that, as shown in FIG. 2, the slidable cover 4 of the main body 1 is moved to a certain position in order to expose the first air vent 10a. By exposing the first air vent 10a, the moisture in the air is adsorbed on the first through third gels 12a, 12b and 12c placed in each of the storages of the main body 1, and the color of them gradually changes from blue to light pink.

At this time, the first gel 12a, which is closest to the first vent 10a, changes its color, and specifically, the color of the first gel 12a changed from its portion, which is closest to the first vent 10a. Thus, for a while, the color of the first gel 12a at its portion, which is furthest to the first vent 10a, is not started discoloration. After that, over time, all region of the first gel 12a uniformly is change to deep pink.

Generally, the period for the complete discoloration is set for one month.

The 2nd gel 12b starts discoloration from the portion, which is closest to the second vent 10b, about 2 weeks after the start of use, and completely changes its color about 1 month after the start of the discoloration. Therefore, by observing the first and second gels 12a and 12b, it can be recognized that one month and two weeks have passed since the start of use. Because the same applies to the third gel 12c, it can be recognized that two months have passed since the start of use when all gels are completely discolored to deep pink.

When the indicator 100 is used again, the double-sided tape 5 and the slidable cover 4 are initially detached from the main body 1, and then the indicator 100 is heated in a microwave for several minutes. As a result, the first through third gels 12a, 12b, and 12c turned to blue from the pink by drying. Then, the removed double-sided tape 5 and the removed slidable cover 4 may be attached in the original location. Therefore, the indicator 100 can be attached to another product to be used, and the expiration date or best-by date can be visually confirmed by watching the color of gels in the reused indicator 100.

While the invention has been described with reference to illustrative embodiments, this description is not intended to be construed in a limiting sense. Thus, shapes, size and physical relationship of each component are roughly illustrated so the scope of the invention should not be construed to be limited to them. Further, to clarify the components of the invention, hatching is partially omitted in the cross-sectional views. Moreover, the numerical description in the embodiment described above is one of the preferred examples in the preferred embodiment so that the scope of he invention should not be construed to limit to them.

In the preferred embodiment, identical gels are used for the first through third gels 12a, 12b and 12c. However, different gels can be used. For example, the second gel12b, which is adsorbed with dichloroline tetraphenylporphyrin chloride, may be used. In such a case, the initial color is set as green, and the color may be changed from green to yellow after absorbing moisture, so that the passage of time can be visually observed more clearly. Further, a first slidable plate may be formed between the first storage 1a and the second storage 1b, and a second slidable plate may be formed between the second storage 1b and the third storage 1c. In this case, it is possible to start decoloring the second gel 12b by moving the first plate. By doing so, the discoloration of the second gel 12b can be started by sliding the first partition plate after the first gel 12a is completely discolored to deep pink.

Various other modifications of the illustrated embodiment will be apparent to those skilled in the art on reference to this description. Therefore, the appended claims are intended to cover any such modifications or embodiments as fall within the true scope of the invention.

We claim:

1. A reusable best-by date indicator comprises:
a main body, which is made of a transparent material, having a plurality of storages, the main body having a first air vent at one end through which outside air can be drawn in and a second air vents between the storages;
a plurality of silica gels, each of which is stored in the storages, respectively, the gels changing their color depending on the degree of moisture absorption;
a slidable cover that is placed near the first air vent of the body and exposes the first air vent by slide; and
a double-sided tape attached to the back surface of the body.

2. A reusable best-by date indicator, as claimed in claim 1, wherein the main body made of plastic with heat resistant material.

3. A reusable best-by date indicator, as claimed in claim wherein the silica gel is formed of silica gel type A.

4. A reusable best-by date indicator, as claimed in claim 1, wherein the silica gel is formed of silica gel type A.

5. A reusable best-by date indicator as claimed in claim 1, wherein the slidable cover is detachably attached near the first air vent of the main body, whereby the first air vent is exposed by sliding the cover.

6. A reusable best-by date indicator as claimed in claim 2, wherein the slidable cover is detachably attached near the first air vent of the main body, whereby the first air vent is exposed by siding the cover.

7. A reusable best-by date indicator as claimed in claim 4, wherein the slidable cover is detachably attached near the first air vent of the main body, whereby the first air vent is exposed by sliding the cover.

8. A reusable best-by date indicator as claimed in claim 5, wherein the slidable cover is detachably attached near the first air vent of the main body, whereby the first air vent is exposed by sliding the cover.

9. A reusable best-by date indicator as claimed in claim 1, wherein the silica gels are formed of the same material.

10. A reusable best-by date indicator as claimed in claim 1, wherein each of silica gels is formed of a different material, and wherein each of the silica gels changes to differently color after oisture absorption.
